(19) United States
(12) Patent Application Publication
(10) Pub. No.: US 2012/0282062 A1
(43) Pub. Date: Nov. 8, 2012

(54) Nail screw, twin spikes, twin nails

(75) Inventor: Klaus Wilhelm Scheel, Mississauga (CA)

(73) Assignee: Klaus Wilhelm Scheel, Mississauga (CA)

(21) Appl. No.: 13/506,559

(22) Filed: Jun. 5, 2012

(30) Foreign Application Priority Data
May 3, 2011 (CA) 2,737,807CA

(51) Int. Cl. F16B 15/00; F16B 35/00

(52) U.S. Cl. 411/389; 411/388; 411/460

(57) ABSTRACT

The invention provides an alternative improved use of using screws, spikes and nails in joining pieces of wood. The intent of making use of the above named devices is to use a simple procedure to join separate pieces of wood using the Nail Screw or Twin Spike or Twin Nail. This is easily accomplished by using a Drill and Bit as the primary method by drilling the Nail Screw end into the wood. The secondary method would be to hammer the Twin Spike or Twin Nail using a simple tool fitting over the shank. For either method, in most cases, pre drilling would be appropriate. When using the Nail Screw, pre drilling would simplify the wood joinery. The end result would be that in most cases no metal part is visible after completion of the task.

The invention provides an improved and different use of screws, spikes and nails.

### BACKGROUND OF THE INVENTION

Screws, spikes and nails, have been around for a long time. An examination of the Patent Data Base reveals that a Patent was issued
under: CA 36766
Title: SPIKE, SCREW AND NAIL
CPC: 85/45
Inventors and Owners: EVEREST, WILLIAM EDWARD USA
   RUSSELL, ALBERT H. USA
   PALEN, HASBROUCK O. USA
Issued: Jun. 6, 1891

The search criteria for “ Twin Spikes ” and “ Twin Nails ” revealed no Patent designations against them.

### SUMMARY OF THE INVENTION

Considered broadly, Spikes, Screws and Nails, have been around for a long time. Nail Screws, Twin Spikes and Twin Nails should be considered an augmentation as well as an improvement to these. The main description of the Nail Screw combination would be an upside down metal spike connected to a lower metal pin with a spiral thread running around it. Depending on type, there could be a head in the middle of this device or it could be shaped like a metal spike without a head.

The Twin Spikes and Twin Nails are also described as an upper metal pin with a sharp end joined in the middle by a head with a lower metal pin that is sharp at the opposite end of the device.

In the drawings, which form a part of this specification,

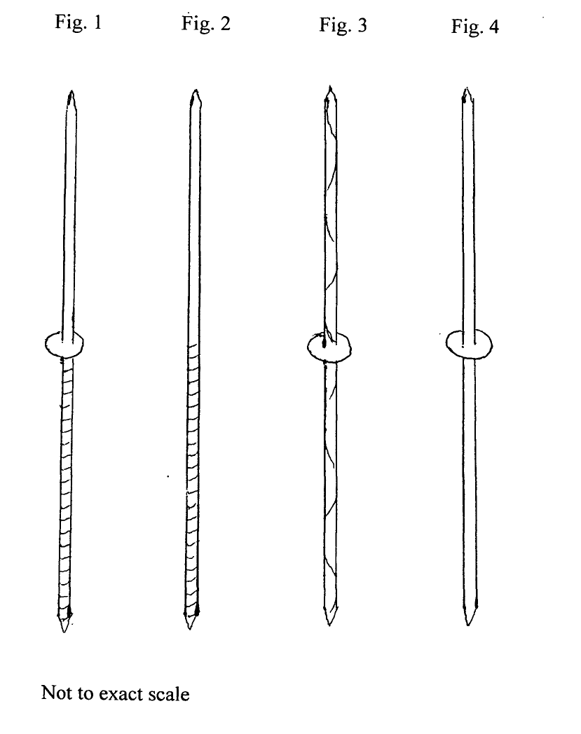

FIG. 1 is a semi-diagrammatic view of the body of the Nail Screw with a head in the middle.

FIG. 2 is a semi-diagrammatic view of the body of a Nail Screw without a head in the middle

FIG. 3 is a semi-diagrammatic view of a Twin Spike with a head in the middle.

FIG. 4 is a semi-diagrammatic view of a Twin Nail with a head in the middle.

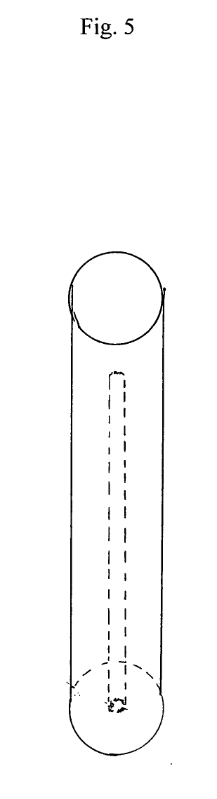

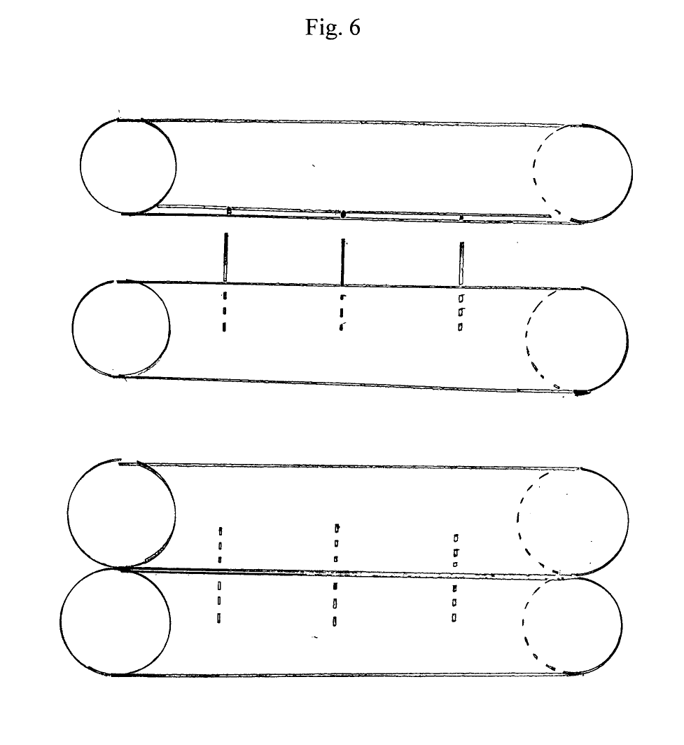

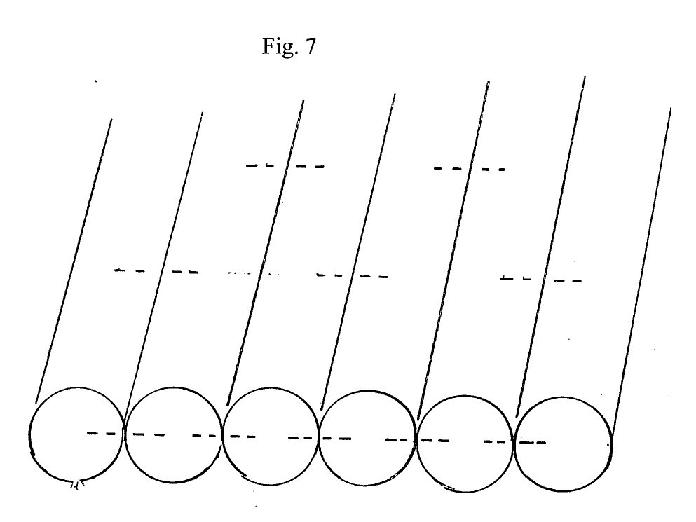

FIG. 5 is a semi-diagrammatic view of the application tool required that fits over the shank at one end of a Twin Spike or a Twin Nail before hammering the device into the wood. This application tool is not used for the Nail Screw combination with a head in the middle, FIG. 1, nor is it being used for the Nail Screw combination without head, FIG. 2. For these devices an electric drilling tool is the recommended application tool. The mouth of the drilling tool is placed over the nail end of the Nail Screw and fastened before drilling the screw end into the wood. For an easier application, pre drilling for both the screw end and nail end, should be considered. In addition, for the Nail Screw with head FIG. 1, countersinking for the head should be considered.

FIG. 6 describes the methods of joining the wood pieces as follows: After placing the Nail Screws in the first piece of wood, using the method described in FIG. 5 above, the second piece of wood should be lined up against the first piece in the place desired, to mark the entry points for the nail and spike ends and hammered in slightly. The pieces should then be separated. For easier application, the second wood piece entry points of the nail or spike ends of the device, should then be pre-drilled with an electric drill and bit to the extent desirable to ease the hammering-in process joining the pieces of wood.

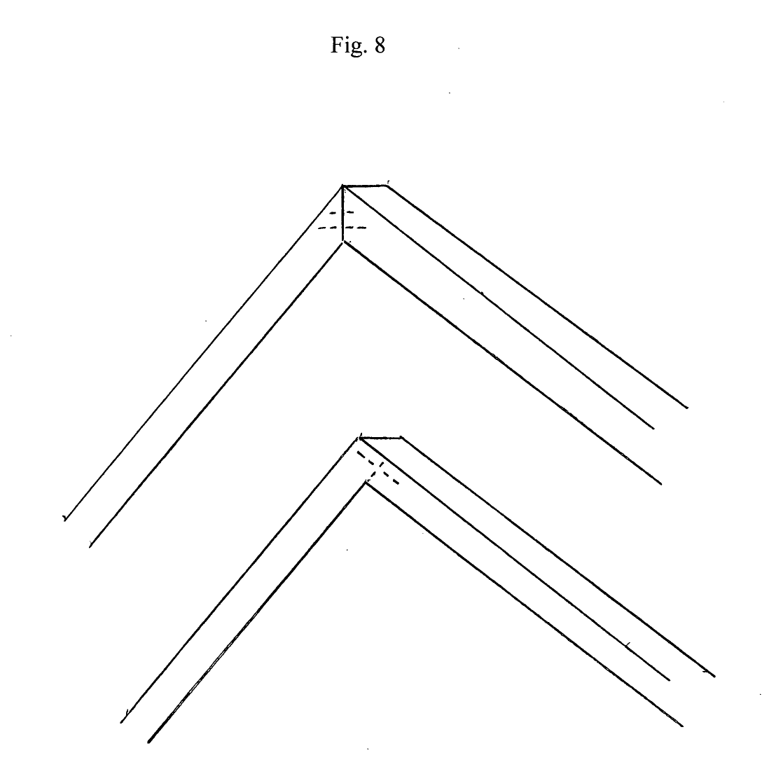

FIG. 7 another illustration of the wood joinery process using the identified methods in FIG. 5 and FIG. 6 respectively.

FIG. 8 another illustration of the wood joinery process using the identified methods in FIG. 5 and FIG. 6 respectively.

1. The Nail Screw combination is the most part of this invention, no claim is made that nails and screws are being replaced in their present usage or format, rather the claim is made that the Nail Screw combination as illustrated in drawing FIG. 1 with a head in the middle and drawing FIG. 2 without a head, is an augmentation of nails and screws in its application of joining wood pieces.

2. Furthermore, the claim is made that the Twin Spikes or Twin Nails as illustrated in drawing FIG. 3 and FIG. 4 respectively, are also an augmentation to spikes and nails in their application of joining wood pieces.

3. The size and dimensions of individual parts of the Nail Screw, Twin Nails and Twin Spikes will vary, depending of size and dimensions of the pieces of wood to be joined by them.
